(19) United States
(12) Patent Application Publication
(10) Pub. No.: US 2019/0225778 A1
(43) Pub. Date: Jul. 25, 2019

(54) TIRE WITH TREAD CONTAINING VEGETABLE OIL EXTENDED HIGH TG STYRENE/BUTADIENE ELASTOMER AND TRACTION RESIN

(71) Applicant: The Goodyear Tire & Rubber Company, Akron, OH (US)

(72) Inventors: Marc Weydert, Bertrange (LU); Jerome Joel Daniel Delville, Rehon (FR); Mathias Meyer, Trier (DE); Stephan Franz Westermann, Trier (DE); Marie-Laure Stephanie Milan, Bertrange (LU)

(21) Appl. No.: 15/876,471

(22) Filed: Jan. 22, 2018

(51) Int. Cl. C08L 9/06; C08L 93/04; C08L 45/02; B60C 1/00; C08K 5/11; C08K 3/36; C08K 5/548

(52) U.S. Cl. CPC C08L 9/06; C08L 93/04; C08L 45/02; C08K 5/548; C08K 5/11; C08K 3/36; B60C 1/0016

(57) ABSTRACT

This invention relates to a tire with high performance tread of rubber composition for promoting tread durability and traction. For such purpose, a tread rubber composition is provided which contains a high Tg solvent solution polymerization prepared styrene/butadiene elastomer (SSBR) together with precipitated silica reinforcement and traction resin. The invention includes extension of the uncured high Tg SSBR by triglyceride vegetable oil instead of petroleum based oil.

### FIELD OF THE INVENTION

This invention relates to a tire with high performance tread of rubber composition for promoting tread durability and traction. For such purpose, a tread rubber composition is provided which contains a high Tg solvent solution polymerization prepared styrene/butadiene elastomer (SSBR) together with precipitated silica reinforcement and traction promoting resin. The invention includes extension of the uncured high Tg SSBR with triglyceride vegetable oil.

### BACKGROUND OF THE INVENTION

Tires are sometimes desired which have high performance treads which promote traction and durability.

It is desired to provide tread rubber containing a high Tg (high glass transition temperature property) solvent solution polymerization prepared styrene/butadiene rubber (SSBR) to promote wet traction for the tread rubber composition.

For such purpose, it is desired for the SSBR to have a high Tg of at least −20° C. and desirably in a range of from about −20° C. to about +10° C. It is desired for the high Tg SSBR to have a bound styrene content in a range of from about 25 to about 50, alternately from about 25 to about 40, percent. It is further desired for the high Tg SSBR to have a vinyl 1,2-content based on its polybutadiene portion of at least about 10, alternately in a range of from about 10 to about 80, or alternatively in a range of from about 20 to about 70, percent.

Reinforcing filler for such rubber composition is desired to be comprised of a combination of rubber reinforcing carbon black and precipitated silica (amorphous synthetic precipitated silica) composed primarily of precipitated silica, desirably at least about 50 to about 100, alternately about 70 to about 99 weight percent precipitated silica. The reinforcing filler is to contain silica coupler (silica coupling agent) for precipitated silica.

Historically, such high Tg SSBR's may be extended with petroleum based rubber processing oil at the SSBR manufacturing facility by blending the petroleum oil with an SSBR polymerizate (polymerization cement comprised of the high Tg SSBR and solvent used for its preparation by polymerization of styrene and 1,3-butadiene monomers) prior to recovery of the high Tg SSBR from its polymerizate and thereby prior to blending the high Tg SSBR with rubber compounding ingredients at a tire tread manufacturing facility, although additional petroleum based rubber processing oil may thereafter be blended with the high Tg SSBR containing rubber composition which may sometimes be referred to as “free addition” of the petroleum based oil instead of such “extending” of the high Tg SSBR.

The term “extending”, as above indicated, is used to refer to (to describe) pre-blending of the petroleum based oil with the high Tg SSBR (a high viscosity, high molecular weight SSBR) in a relatively low viscosity solvent based cement form of the SSBR. A composite of the petroleum based oil and SSBR is thereafter recovered from the solvent cement (by removing the solvent) as a petroleum based oil “extended” SSBR. The oil extended high Tg SSBR is provided in contrast to free addition of the petroleum based oil to a significantly higher viscosity high Tg SSBR or to the high Tg SSBR containing rubber composition by addition of the petroleum oil to a rubber mixer.

For this invention, it is desired to provide a rubber composition comprised of cis 1,4-polybutadiene rubber and the high Tg SSBR to promote the tire tread traction yet it is also desired to reduce the Tg of the rubber composition to promote the tread traction at lower temperatures by thereby reducing its stiffness as may be evidenced by a reduction of its storage modulus (E′).

For such reduction in Tg of the rubber composition, it desired to evaluate providing the high Tg SSBR in a form of an extended SSBR with vegetable triglyceride oil in a sense of pre-blending the vegetable oil with the high Tg SSBR before recovery from its polymerization cement, instead of the SSBR being extended with petroleum based oil, to thereby evaluate promoting a lower Tg for the rubber composition containing the high Tg SSBR to thereby promote a reduction of its stiffness (e.g. lower storage modulus G′ and higher tan delta values for the rubber composition).

Historically, a vegetable oil such as for example soybean oil, or soy oil, has been used for mixing with various rubber compositions by free oil addition to the rubber composition rather than soy oil extension of the elastomer by addition to its cement at its point of manufacture. For example, and not intended to be limiting, see U.S. Pat. Nos. 7,919,553, 8,100,157 and 8,022,136. Soybean oil has also been used for oil extending emulsion polymerization prepared and organic solution polymerization prepared styrene/butadiene elastomers for some circumstances. For example, see U.S. Pat. No. 8,044,118 and U.S. Patent Publication No. 2013/0289183.

In the description of this invention, the terms “compounded” rubber compositions and “compounds”; where used refer to rubber compositions which have been compounded, or blended, with appropriate rubber compounding ingredients. The terms “rubber” and “elastomer” may be used interchangeably unless otherwise indicated. The amounts of materials are usually expressed in parts of material per 100 parts of rubber by weight (phr).

### SUMMARY AND PRACTICE OF THE INVENTION

In accordance with this invention, a pneumatic tire is provided having a rubber tread having a running surface intended to be ground-contacting, where said tread is comprised of a rubber composition comprised of, based on parts by weight per 100 parts by weight elastomer (phr):

(A) conjugated diene-based elastomers comprised of:
(1) from about 75 to about 100, alternately about 80 to about 95, phr of high Tg styrene/butadiene elastomer (high Tg SSBR) pre-oil extended with vegetable triglyceride oil, wherein said high Tg SSBR has a Tg in a range of from about −20° C. to about +10° C. and a bound styrene content in a range of from about 25 to about 50 percent,
(2) from zero to about 25, alternately from about 5 to about 20, phr of at least one additional conjugated diene-based elastomer comprised of at least one of polybutadiene, cis 1,4-polyisoprene rubber, and additional styrene/butadiene elastomer, desirably a high cis 1,4-polybutadiene rubber having a cis 1,4-isomeric content of at least about 92 percent,

(B) about 80 to about 200, alternately from about 90 to about 140, phr of reinforcing filler comprised of a combination of rubber reinforcing carbon black and precipitated silica where the reinforcing filler is comprised of from about 50 to about 100 weight percent precipitated silica, where said reinforcing filler further contains silica coupler (silica coupling agent) for said precipitated silica having a moiety reactive with hydroxyl groups on said precipitated silica and another different moiety interactive with said diene-based elastomers, and

(C) about 10 to about 70, alternately about 15 to about 50, phr of traction promoting resin (e.g. traction between said tread and ground) comprised of at least one of styrene/alphamethylstyrene copolymer resin, terpene-phenol resin, coumarone-indene resin, petroleum hydrocarbon resin, terpene polymer resin, and rosin derived resin and modified rosin acid resin, desirably comprised of styrene/alphamethylstyrene resin.

In one embodiment, the high Tg SSBR is extended with about 5 to about 40, alternately about 5 to about 30, parts by weight vegetable triglyceride oil per 100 parts by weight of said high Tg SSBR.

In one embodiment, said high Tg SSBR has a vinyl 1,2-content, based on its polybutadiene component, in a range of from about 10 to about 80, alternately about 20 to about 70, percent.

In one embodiment, said rubber composition contains from zero to about 20, alternately up to about 10 or up to about 20, phr of freely added petroleum based oil (in contrast to containing petroleum based oil extended high Tg SSBR).

In one embodiment, said rubber composition contains from about 0 to about 10, alternately up to about 5 or up to about 10, phr of phenol formaldehyde resin to promote tack for the rubber composition.

In one embodiment said traction promoting resin is comprised of at least one of said styrene/alphamethylstyrene resin, rosin acid resin, coumarone-indene resin and terpene-phenol resin, desirably styrene/alphamethylstyrene resin.

In one embodiment, said triglyceride vegetable oil is at least one of sunflower oil, rapeseed oil, canola oil, palm oil, and soybean oil, desirably comprised of at least one of soybean oil and sunflower oil.

In one embodiment, said high Tg SSBR is an end-functionalized high Tg SSBR with at least one functional group reactive with hydroxyl groups on said precipitated silica where said functional groups are comprised of at least one of alkoxy, amine, siloxy and thiol groups.

In one embodiment, said high Tg SSBR or end functionalized high Tg SSBR is tin or silicon coupled.

In further accordance with this invention, said tire tread is provided as a sulfur cured rubber composition.

Various suitable solvent solution polymerization methods for preparing a high Tg SSBR by co-polymerizing styrene and 1,3-butadiene monomers are known in the art, for example, and without an intended limitation, as may be disclosed in one or more U.S. Pat. Nos. 4,843,120; 5,137,998; 5,047,483; 5,272,220; 5,239,009; 5,061,765; 5,405,927; 5,654,384; 5,620,939; 5,627,237; 5,677,402; 6,103,842; and 6,559,240; all of which are fully incorporated herein by reference.

The precipitated silica may, for example, be characterized by having a BET surface area, as measured using nitrogen gas, in the range of, for example, about 40 to about 600, and more usually in a range of about 50 to about 300, square meters per gram. The BET method of measuring surface area might be described, for example, in the Journal of the American Chemical Society, Volume 60, as well as ASTM D3037.

The precipitated silica may, for example, also be characterized by having a dibutylphthalate (DBP) absorption value, for example, in a range of about 100 to about 400, and more usually in a range of from about 150 to about 300, cc/100 g.

Various commercially available precipitated silicas may be used, such as, and not intended to be limiting, silicas from PPG Industries under the Hi-Sil trademark with designations 210, 243, etc.; silicas from Solvey with, for example, designations of Zeosil 1165MP and Zeosil 165GR, silicas from Evonik with, for example, designations VN2 and VN3 and chemically treated precipitated silicas (e.g. composite of pre-hydrophobated precipitated silica) such as for example Agilon™ 400 from PPG Industries.

Representative examples of rubber reinforcing carbon blacks are, for example, and not intended to be limiting, those with ASTM designations of N110, N121, N220, N231, N234, N242, N293, N299, S315, N326, N330, N332, N339, N343, N347, N351, N358, N375, N539, N550, N582, N630, N642, N650, N683, N754, N762, N765, N774, N787, N907, N908, N990 and N991. Such rubber reinforcing carbon blacks may have iodine absorptions ranging from, for example, 9 to 145 g/kg and DBP numbers ranging from 34 to 150 cc/100 g.

The silica coupling agent(s) which may be provided with the precipitated silica for the rubber composition, may be comprised of, for example,

(A) bis(3-trialkoxysilylalkyl) polysulfide containing an average of connecting sulfur atoms in its polysulfide bridge in range of from about 2 to about 4, alternately from about 2 to about 2.6, sulfur atoms, or

(B) a combination of bis(3-trialkoxysilylproyl) polysulfides having an average of connecting sulfur atoms in their polysulfide bridges of:
(1) from about 2 to about 2.6, and
(2) from about 3.2 to about 4,

(C) an organoalkoxymercaptosilane, or

(D) a combination of said bis(3-trialkoxysilylalkyl) polysulfide and organoalkoxymercaptosilane silica coupling agents.

Representative of such bis(3-trialkoxysilylalkyl) polysulfide is bis(3-triethoxysilylpropyl) polysulfide.

Alternately, the precipitated silica may be pre-treated (pre-hydrophobated) with at least one of such silica coupling agent to form a composite thereof prior to addition to the rubber composition.

It is readily understood by those having skill in the art that the vulcanizable rubber composition would be compounded by methods generally known in the rubber compounding art, such as, for example, mixing various additional sulfur-vulcanizable elastomers with said SSBR composite and various commonly used additive materials such as, for example, sulfur and sulfur donor curatives, sulfur vulcanization curing aids, such as activators and retarders and processing additives, resins including tackifying resins and plasticizers, petroleum based or derived process oils as well as vegetable triglyceride oil in addition to said triglyceride oil extended SSBR, fillers such as rubber reinforcing fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Usually it is desired that the sulfur-vulcanizing agent is elemental sulfur. The sulfur-vulcanizing agent may be used in an amount ranging, for example, from about 0.5 to 8 phr, with a range of from 1.5 to 6 phr being often preferred. Typical amounts of processing aids comprise about 1 to about 50 phr. Additional process oils, if desired, may be added during compounding in the vulcanizable rubber composition in addition to the extending soybean oil contained in the soybean oil extended SSBR. Typical amounts of antioxidants may comprise, for example, about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants may comprise, for example, about 1 to 5 phr. Typical amounts of fatty acids, if used, which can include stearic acid comprise about 0.5 to about 3 phr. Typical amounts of zinc oxide may comprise, for example, about 2 to about 5 phr. Typical amounts of waxes comprise about 1 to about 5 phr. Often microcrystalline waxes are used. Typical amounts of peptizers, when used, may be used in amounts of, for example, about 0.1 to about 1 phr. Typical peptizers may be, for example, pentachlorothiophenol and dibenzamidodiphenyl disulfide.

Sulfur vulcanization accelerators are used to control the time and/or temperature required for vulcanization and to improve the properties of the vulcanizate. In one embodiment, a single accelerator system may be used, i.e., primary accelerator. The primary accelerator(s) may be used in total amounts ranging, for example, from about 0.5 to about 4, sometimes desirably about 0.8 to about 1.5, phr. In another embodiment, combinations of a primary and a secondary accelerator might be used with the secondary accelerator being used in smaller amounts, such as, for example, from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Often desirably the primary accelerator is a sulfenamide. If a second accelerator is used, the secondary accelerator is often desirably a guanidine such as for example a diphenylguanidine, a dithiocarbamate or a thiuram compound.

The mixing of the vulcanizable rubber composition can be accomplished by methods known to those having skill in the rubber mixing art. For example, the ingredients are typically mixed in at least two stages, namely at least one non-productive stage followed by a productive mix stage. The final curatives, including sulfur-vulcanizing agents, are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

Vulcanization of the pneumatic tire of the present invention may be generally carried out at conventional temperatures in a range of, for example, from about 150° C. to 200° C. Any of the usual vulcanization processes may be used such as heating in a press or mold with superheated steam or hot air. Such tires can be built, shaped, molded and cured by various methods which are known and will be readily apparent to those having skill in such art.

The following examples are presented for the purposes of illustrating and not limiting the present invention. The parts and percentages are parts by weight, usually parts by weight per 100 parts by weight rubber (phr), unless otherwise indicated.

### EXAMPLE I

In this example, three rubber compositions are evaluated. All three rubber compositions contained 10 phr of high cis 1,4-polybutadiene rubber.

The first rubber composition of Control rubber Sample A represents a proposed high performance silica reinforced tread rubber composition containing two styrene/butadiene elastomers (SSBR's) having Tgs of −14° C. and −31° C. respectively with a mathematical average Tg of the combination of SSBR's of an intermediate Tg of about −23° C.

For the second rubber composition of Experimental rubber Sample B, the silica reinforced rubber composition contained two styrene/butadiene elastomers (SSBRs) having Tgs of −14° C. and −2° C. respectively with a mathematical average Tg of the combination of SSBR's of a higher Tg of about −18° C.

The SSBRs of both of the rubber compositions of Control rubber Sample A and Experimental rubber Sample B were provided as SSBRs pre-extended with petroleum based rubber processing oils.

A small amount of petroleum based rubber processing oil (5 phr thereof) was also freely added to the rubber compositions of Control rubber Sample A and Experimental rubber Sample B.

For the third rubber composition of Experimental rubber Sample C, the petroleum based oil was replaced with soybean oil to provide a vegetable oil extended high Tg SSBR. A small amount (5 phr) of petroleum based rubber processing oil was also freely added to (mixed with) the rubber composition. The high Tg SSBR (before its soybean oil extension) had a higher Tg of about −14° C. compared the average Tgs of the SSBRs of Control rubber Sample A and Experimental rubber Sample B of −23° C. and −18° C., respectively.

The compositions of the rubber Samples are summarized in Table 1 where the parts of ingredients are expressed in terms of parts by weight per 100 parts by weight elastomer(s), (phr) unless other noted.

TABLE 1

| | Rubber Samples (phr) | | |
|---|---|---|---|
| | Control | Experimental | Experimental |
| Materials | A | B | C |
| Non-Productive Mixing Steps | | | |
| Cis 1,4-polybutdiene¹ | 10 | 0 | 0 |
| Cis 1,4-polybutadiene² | 0 | 10 | 10 |
| SSBR(1), petroleum oil extended³ | 69 | 69 | 0 |
| (50 parts SSBR, 19 parts oil) | | | |
| SSBR(2), petroleum oil extended⁴ | 0 | 55 | 0 |
| (40 parts SSBR, 15 parts oil) | | | |
| SSBR(3), petroleum oil extended⁵ | 55 | 0 | 0 |
| (40 parts SSBR, 15 parts oil) | | | |
| SSBR(4), soybean oil extended⁶ | 0 | 0 | 108 |
| (90 parts SSBR, 18 parts oil) | | | |
| Precipitated silica⁷ | 106 | 112 | 112 |
| Carbon black(N134)⁸ | 5 | 0 | 0 |
| Silica coupler⁹ | 10 | 11 | 11 |
| Petroleum processing oil¹⁰ | 6 | 5 | 5 |
| Coumarone-indene resin¹¹ | 6 | 0 | 0 |
| Styrene/alphamethylstyrene resin¹² | 0 | 12 | 12 |
| Phenol formaldehyde resin¹³ | 0 | 5 | 5 |
| White gum resin¹⁴ | 0 | 3 | 3 |
| Fatty acid¹⁵ | 2.5 | 0 | 0 |
| Microcrystalline wax | 2 | 2 | 2 |
| Antioxidant | 5 | 5 | 5 |
| Zinc fatty acid processing aid¹⁶ | 2 | 3 | 3 |
| Productive Mixing Step | | | |
| Zinc oxide | 3 | 1 | 1 |
| Silica coupler¹⁷ | 2 | 2 | 2 |
| Sulfur | 2 | 1 | 1 |
| Sulfur vulcanization accelerators¹⁸ | 6 | 6 | 4 |

¹Cis 1,4-polybutadiene rubber having a cis 1,4-content of at least about 95 percent and a Tg of about −104° C. as BUD1207 ™ from The Goodyear Tire & Rubber Company prepared by nickel based catalysis of 1,3-butadiene monomer
²Cis 1,4-polybutadiene rubber having a cis 1,4-content of at least about 95 percent and a Tg of about −104° C. as BUD1223 ™ from The Goodyear Tire & Rubber Company prepared by neodymium based catalysis of 1,3-butadiene monomer.
³Solution polymerization prepared styrene/butadiene elastomer (SSBR), extended with 37.5 parts by weight petroleum based rubber processing oil per 100 parts by weight of SSBR, where the SSBR has a moderate Tg of about −31° C. and a styrene content of about 40 percent and a vinyl 1,2-content based on its polybutadiene component of about 24 percent as SLR6430 ™ from the Trinseo Company. The SSBR is reported in Table 1 in terms of the oil extended SSBR (SSBR containing the petroleum oil extension).
⁴Solution polymerization prepared styrene/butadiene elastomer (SSBR), extended with 37.5 parts by weight petroleum based rubber processing oil per 100 parts by weight of SSBR, where the SSBR has a high Tg of about −2° C. and a styrene content of about 40 percent and a vinyl 1,2-content based on its polybutadiene component of about 65 percent as SE6233 ™ from the Sumitomo Company. The high Tg SSBR is reported in Table 1 in terms of the oil extended SSBR (SSBR containing the petroleum oil extension).
⁵Solution polymerization prepared styrene/butadiene elastomer (SSBR), extended with 37.5 parts by weight petroleum based rubber processing oil per 100 parts by weight of SSBR, where the SSBR has a high Tg of about −14° C. and a styrene content of about 34 percent and a vinyl 1,2-content based on its polybutadiene component of about 58 percent as E680 ™ from the Asahi-Kasei Company. The SSBR is reported in Table 1 in terms of phr of the oil extended SSBR (SSBR containing the petroleum oil extension).
⁶Solution polymerization prepared styrene/butadiene elastomer (SSBR), extended with 20 parts by weight soybean oil per 100 parts by weight of SSBR, where the SSBR has a high Tg of about −14° C. and a styrene content of about 33 percent and a vinyl 1,2-content based on its polybutadiene component of about 54 percent as SLF33SOY from The Goodyear Tire & Rubber Company. The SSBR is reported in Table 1 in terms of the soybean oil extended SSBR (SSBR containing the soybean oil extension).
⁷Precipitated silica having a nitrogen surface area of about 210 m² as Zeosil Premium 200MP ™ silica from the Solvay Company
⁸Rubber reinforcing carbon black as N134, an ASTM designation
⁹Silica coupler as a bis(3-triethoxysilylpropyl) polysulfide having an average of from about 2 to about 2.6 connecting sulfur atoms in its polysulfidic bridge as Si266 ™ from Evonik
¹⁰Petroleum based rubber processing oil comprised primarily of TDAE oil
¹¹Coumarone-indene resin having a softening point of about 100° C.
¹²Styrene/alphamethylstyrene resin having a styrene content of about 45 percent and a softening point of about 85° C.
¹³Phenol formaldehyde resin as SP1068 ™ from the SI Group
¹⁴White gum resin from AV Pound, a rosin based resin
¹⁵Fatty acid comprised of a combination of at least one of stearic, palmitic and oleic acids
¹⁶Rubber processing aid, fatty acid based, comprised of zinc salt of fatty acid as EF44 ™ from Schill & Seilacher Company
¹⁷Silica coupler comprised of bis(3-triethoxysilylpropyl) polysulfide with an average im a range of about 3.4 to about 4 connecting sulfur atoms in its polysulfidic bridge as Si69 ™ from Evonik Company contained on a carbon black carrier in a 50/50 ratio thereof as X-50-S ™
¹⁸Sulfur vulcanization accelerators comprised of sulfenamide and diphenylguanidine.

The non-productive mixing (NP) of the rubber compositions for Control rubber Sample A and Experimental rubber Sample C was comprised of two ingredient addition mixing stages and two re-milling mixing stages without ingredient addition followed by a final productive (P) mixing stage where the sulfur and vulcanization accelerators were added. For Experimental rubber Sample B, only one re-milling mixing stage was used.

In Table 2 various physical properties of the rubber compositions of Control rubber Sample A and Experimental rubber Samples B and C are reported. The rubber samples were cured at a temperature of about 170° C. for about 10 minutes.

TABLE 2

| | Rubber Samples (phr) | | |
|---|---|---|---|
| | | Experimental | Experimental |
| | Control A | B | C |
| Cis 1,4-polybutadiene rubber | 10 | 10 | 10 |
| SSBR(1) extended with | 50 | 50 | 0 |
| petroleum oil | | | |
| SSBR(2) extended with | 0 | 0 | 0 |
| petroleum oil | | | |
| SSBR(3) extended with | 40 | 40 | 0 |
| petroleum oil | | | |
| SSBR(4) extended with | 0 | 0 | 90 |
| soybean oil | | | |
| Rebound, Zwick (%) | | | |
| Rebound at 0° C. | 8.6 | 8 | 8.6 |
| Rebound at 100° C. | 53 | 54 | 49 |
| Rubber Properties | | | |
| Ultimate elongation (%) | 458 | 482 | 462 |
| Tensile strength (MPa) | 83 | 91 | 76 |
| Modulus, Ring | | | |
| 100 percent (MPa) | 2.2 | 2.3 | 2.2 |
| 300 percent (MPa) | 9.9 | 9.9 | 8.9 |
| Shore A Hardness | 68 | 74 | 74 |
| Rebound, at 23° C., (%) | 21 | 16 | 21 |
| Average polymer matrix Tg | −31.5° C. | −26.7° C. | −23° C. |
| (calculated) (Tg based on | | | |
| Fox equation, a well-known | | | |
| equation to those having | | | |
| skill in such art) | | | |
| Rubber composition Tg (at a | −19.2° C. | −13.4° C. | −20.1° C. |
| maximum tan delta of a tan | | | |
| delta instrumental sweep test) | | | |
| E′ at 0° C. (MPa)¹ | 41.7 | 62.7 | 45.2 |
| E′ at 30° C. (MPa)¹ | 20.1 | 21.3 | 21.6 |

¹Modulus (E′) determined by Eplexor ™ instrument (an instrument of the Gabo Company)

From Table 2 it can be seen that the physical properties of the rubber compositions fall within a similar and acceptable range of physical values for each of the Control and Experimental rubber samples. Therefore, performances of the rubber compositions can be reasonably compared in terms of their tensile strength, elongation and modulus properties as well as Shore A hardness values.

However, from Table 2, the Tg values for the polymer matrix and rubber composition are observed as tabulated in the following Table 3 where the rubber composition Tg containing the increased polymer matrix Tg of −23° C. surprisingly decreased to a value of −20.1° C. for Experimental rubber Sample C employing the high Tg SSBR which was pre-soybean oil extended.

TABLE 3

| | Control A | Experimental B | Experimental C |
|---|---|---|---|
| Polymer matrix Tg | −31.5° C. | −26.7° C. | −23° C. |
| Rubber composition Tg | −19.2° C. | −13.4° C. | −20.1° C. |
| E′ at 0° C. (MPa) | 41.7 | 62.7 | 45.2 |
| E′ at 30° C. (MPa) | 20.1 | 21.3 | 21.6 |

From Table 3 it is seen that, where the polymer matrix Tg of −26.7° C. for Experimental rubber Sample B was significantly higher than the polymer matrix Tg of −31.5° C. for Control rubber Sample A, it would be expected that rubber Experimental rubber Sample B would provide a predictive and beneficially improved wet grip (wet traction) for the running surface of a tire tread of rubber composition.

However, such increase of polymer matrix Tg for Experimental rubber Sample B compared to the polymer matrix Tg of Control rubber Sample A was accompanied by a higher rubber composition Tg of −13.4° C. compared to a rubber composition Tg of −19.2° C. for Control rubber Sample A. Therefore, Experimental rubber Sample B is expected to stiffen more than Control rubber Sample A at low ambient temperatures, which in turn would negatively affect the wet grip (traction) performance of the tire tread of such rubber composition at low ambient temperatures.

In contrast, Experimental rubber Sample C, containing the soybean oil extended high Tg SSBR with a polymer matrix Tg of −23° C., reported a Tg of −20.1° C. for its rubber composition.

Therefore, although Experimental rubber Sample C containing the soybean oil extended high Tg SSBR reported a beneficial higher polymer matrix Tg value of −23° C. compared to the polymer matrix Tg of −31.5° C. for Control rubber Sample A, it is surprisingly seen that the rubber composition Tg of −20.1° C. for Experimental rubber Sample C was comparable to the rubber composition Tg of −19.2° C. for Control rubber Sample A.

This is considered to be a beneficial discovery in a sense of that such higher polymer matrix Tg (−23° C.) would be expected to provide a beneficially improved wet grip (wet traction) for the running surface of a tire tread of Experimental rubber Sample C compared to Control rubber Sample A. Also, the comparatively lower rubber composition Tg (−20° C.) of Experimental rubber Sample C would be expected to enable Experimental rubber Sample C to avoid the low temperature stiffening of the rubber composition thereby maintaining the wet grip (wet traction) at lower ambient temperatures.

Therefore, a tire tread of the rubber composition of Experimental rubber Sample C is expected to display improved wet grip performance at higher ambient temperatures without significant loss of wet grip (wet traction) at lower ambient temperatures. This expectation is illustrated by the stiffening behavior (E′ values) of the rubber compositions at a lower temperature of 0° C. as compared to a higher temperature of 30° C. For example, all three rubber compositions (Control rubber Sample A and Experimental rubber Samples B and C) have similar dynamic stiffness E′ values at 30° C. ranging from 20.1 to 21.6 MPa. However, Experimental rubber Sample B stiffens significantly more at lower ambient temperatures (e.g. 0° C.) than either of Control rubber Sample A or Experimental rubber Sample C with a substantially greater value of 62.7 MPa as compared to values of 41.7 and 45.2 MPa for Control rubber Sample A and Experimental rubber Sample C. Therefore, Experimental rubber Sample B is expected to provide an advantage of a greater predictive wet grip performance over Control rubber Sample A at the higher ambient temperatures but lose that advantage at lower ambient temperatures, while Experimental rubber Sample C, which contains the soybean oil extended SSBR elastomer, maintained an improved balance of predictive wet grip performance over a wider range of ambient temperatures as compared to both of Control rubber Sample A and Experimental rubber Sample B, even at lower ambient temperatures.

From Example I it is concluded that Experimental rubber Sample C, containing the soybean oil extended SSBR, was discovered to demonstrate the beneficially best balance of providing wet grip performance at both high and low ambient temperatures and represents a significant discovery.

### EXAMPLE II

Pneumatic rubber tires of size 205/55R16 were prepared with treads of rubber Samples A, B and C of Example I, identified in this Example II as Tires A, B and C, respectively, and evaluated for their comparative breaking performance on a vehicle as a measure of their road traction. The tire rolling resistance for the tires was evaluated in a dynamic test laboratory wheel. The test values for the tires having a tread of Control rubber Sample A are normalized to a value of 100 and the test values for tires with treads of Experimental rubber Samples B and C are reported relative to the normalized values for the tire with tread of Control rubber Sample A.

Dry braking relates to stopping distance for the tires on dry pavement.

The term “ABS” rating means the normalized stopping distance values on a car equipped with anti-lock braking system relative to the normalized stopping distance for the tire with the tread of Formulation A. Higher ratings are better ratings for the tire (e.g. shorter stopping distance).

The term “wet high mu ABS rating” relates to ABS braking on a high mu asphalt surface (e.g. an asphalt surface displaying a low coefficient of friction).

The term “wet low mu ABS rating” relates ABS braking on a low mu asphalt surface (e.g. a smooth wet asphalt surface displaying a low coefficient of friction).

The term “rolling resistance rating” relates to the rolling resistance coefficient as determined by the ISO28580:2009 laboratory test. Higher ratings represent beneficially better ratings for the tire (e.g. lower rolling resistance coefficient).

The tire test results are summarized in Table 4.

TABLE 4

| | Ambient | | | |
|---|---|---|---|---|
| | Atmospheric | Tires | | |
| Tire Test Results | Temperature | A | B | C |
| Dry braking ABS rating | 22-22° C. | 100 | 101 | 102 |
| Wet high mu ABS rating | 22-25° C. | 100 | 103 | 108 |
| Wet low mu ABS rating | 21-23° C. | 100 | 106 | 107 |
| Wet high mu ABS rating | 11-12° C. | 100 | 97 | 100 |
| Wet low mu ABS rating | 13° C. | 100 | 97 | 101 |
| (higher is better for predictive better | | | | |
| tread traction & shorter vehicular | | | | |
| stopping distance) | | | | |
| Rolling resistance rating | Laboratory | 100 | 94 | 98 |
| (higher is better for predictive | Test | | | |
| beneficially reduced tire rolling | | | | |
| resistance) | | | | |

From Table 4, at ambient testing temperatures in range of from about 22° C. to about 25° C., it can be seen that the traction (grip) property for the tire with the Experimental rubber Sample B tread is improved as compared to the tire with Control rubber Sample A tread as illustrated by a beneficial increase in wet braking performance of 103 and 106, respectively, at an ambient temperature of 21° C. to 25° C. Relative to the tire with the Control rubber Sample A tread composition, the tire with Experimental rubber Sample B tread contains a combination of an SSBR with higher Tg and higher precipitated silica reinforcing filler content.

However, at comparatively lower ambient testing temperatures in a range of from about 10° C. to about 13° C., the wet braking performance of the tire with Experimental rubber Sample B tread is inferior to the tire with Control rubber Sample A tread as evidenced by a comparative wet braking performance of 97. This can be understood to be a consequence of the higher stiffness of Experimental rubber Sample B at the lower temperature due to its higher Tg promoted by the increased content of the high Tg SSBR.

This is considered as being significant in that it is desirable to achieve improved tire breaking performance at higher ambient temperatures while at least substantially maintaining the tire breaking performance at lower ambient temperatures.

Such desired properties were achieved by the tire with Experimental rubber Sample C rubber composition where an SSBR with an increased Tg (a higher compositional Tg) was used in combination with a reduced Tg of the rubber composition of Experimental rubber Sample C. The reduced compositional Tg of the Experimental rubber Sample C was achieved by soybean oil extending, instead of petroleum oil extending, the high Tg SSBR elastomer.

From such tire tests it is concluded that the tire with a tread of rubber composition of Experimental rubber Sample C, compared with treads rubber compositions of Control rubber Sample A and Experimental rubber Sample B provided the best balance of providing wet grip performance at both high and low ambient temperatures.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire is provided having a rubber tread intended to be ground-contacting, where said tread is comprised of a rubber composition comprised of, based on parts by weight per 100 parts by weight elastomer (phr):
(A) conjugated diene-based elastomers comprised of:
(1) from about 75 to about 100 phr of high Tg styrene/butadiene elastomer (SSBR) pre-extended with vegetable triglyceride oil, wherein said SSBR has a Tg in a range of from about −20° C. to about +10° C. and a bound styrene content in a range of from about 25 to about 50 percent,
(2) from zero to about 25 phr of at least one additional conjugated diene-based elastomer comprised of at least one of polybutadiene, cis 1,4-polyisoprene rubber, and additional styrene/.butadiene elastomer,
(B) about 80 to about 200 phr of reinforcing filler comprised of a combination of rubber reinforcing carbon black and precipitated silica where the reinforcing filler is comprised of from about 50 to about 100 weight percent precipitated silica, where said reinforcing filler further contains silica coupler for said precipitated silica having a moiety reactive with hydroxyl groups on said precipitated silica and another different moiety interactive with said diene-based elastomers, and
(C) about 10 to about 70 phr of traction promoting resin comprised of at least one of styrene/alphamethylstyrene copolymer resin, terpene-phenol resin, coumarone-indene resin, petroleum hydrocarbon resin, terpene polymer resin, and rosin derived resin and modified rosin acid resin, desirably comprised of styrene/alphamethylstyrene resin.

2. The tire of claim 1 where said high Tg SSBR is extended with about 5 to about 40 parts by weight vegetable triglyceride oil per 100 parts by weight of said high Tg SSBR.

3. The tire of claim 1 wherein said vegetable triglyceride oil is comprised of at least one of soybean oil and sunflower oil.

4. The tire of claim 1 wherein said high Tg SSBR has a vinyl 1,2-content in a range of from about 10 to about 80 percent based on butadiene content.

5. The tire of claim 1 wherein said coupling agent is comprised of bis(3-triethoxysilylpropyl) polysulfide having an average of connection sulfur atoms in its polysulfide bridge in a range of from about 2 to about 4 sulfur atoms, or organoalkoxymercaptosilane or combination thereof.

6. The tire of claim 4 wherein said precipitated silica is pre-treated with at least one of said coupling agents.

7. The tire of claim 1 wherein said tread rubber composition contains from zero to about 20 phr of freely added petroleum based rubber processing oil.

8. The tire of claim 1 wherein said tread rubber composition contains from about 0 to about 10 phr of phenol formaldehyde resin.

9. The tire of claim 1 wherein said traction promoting resin for said tread rubber composition is comprised of at least one of said styrene/alphamethylstyrene resin and terpene-phenol resin.

10. The tire of claim 1 where said triglyceride vegetable oil is comprised of at least one of sunflower oil, rapeseed oil, canola oil, palm oil and soybean oil.

11. The tire of claim 1 wherein said SSBR is an end-functionalized styrene/butadiene elastomer with functional groups reactive with hydroxyl groups on said precipitated silica comprised of at least one of alkoxy, amine, siloxy and thiol groups.

12. The tire of claim 1 wherein said SSBR is tin or silicon coupled.

13. The tire of claim 1 wherein said high Tg SSBR has a vinyl 1,2-content in a range of about 10 to about 80 based on its butadiene content and wherein said tread rubber composition contains up to 20 phr of freely added petroleum based rubber processing oil and up to 10 phr of phenol formaldehyde resin.

14. The tire of claim 13 wherein said triglyceride vegetable oil is comprised of soybean oil.

15. The tire of claim 13 wherein said triglyceride oil is comprised of sunflower oil.

16. The tire of claim 13 wherein the traction promoting resin is comprised of at least one of said styrene/alphamethylstyrene resin and terpene-phenol resin.

17. The tire of claim 16 wherein said traction promoting resin includes a rosin acid resin.

18. The tire of claim 11 wherein the traction promoting resin for said tread rubber composition is comprised of at least one of said styrene/alphamethylstyrene resin and terpene-phenol resin.

19. The tire of claim 18 wherein said traction promoting resin includes a rosin acid resin.
